(19) United States
(12) Patent Application Publication
(10) Pub. No.: US 2004/0017369 A1
(43) Pub. Date: Jan. 29, 2004

(54) Method and apparatus for computer generation of electronic model images

(76) Inventors: Bruce Willard Hultgren, Victoria, MN (US); Timothy W. Vadnais, Victoria, MN (US); Michael Craig Marshall, Savage, MN (US); Grant James Cermak, Minneapolis, MN (US)

Correspondence Address: MERCHANT & GOULD PC, P.O. BOX 2903, MINNEAPOLIS, MN, 55402-0903, US

(21) Appl. No.: 10/350,302

(22) Filed: Jan. 22, 2003

Related U.S. Application Data
(60) Provisional application No. 60/351,270, filed on Jan. 22, 2002.

(51) Int. Cl. G06T 17/20

(52) U.S. Cl. 345/423

(57) ABSTRACT

A method, apparatus, and article of manufacture provide a process for generating an electronic model image constructed using polygons to represent the surface of an object. The process scans an object to generate a plurality of surface points in a common coordinate system and generates a initial polygon representation for the object surface by connecting surface points to nearest neighbors. The process then divides the initial polygon representation into a plurality of regions of common spatial orientation, slices the regions of common spatial orientation into slices that are oriented perpendicular to the common spatial orientation, determines line segments at locations in which the slices intersect the polygons in the initial polygon representation, combines the line segments into a stripe of continuous line segments that represents the surface of the scanned object at the location of the slice, generates a polygonal mesh using endpoints from adjacent stripes of continuous line segments within each region of common spatial orientation, and generates a polygonal mesh using endpoints of continuous line segments along adjacent edges of regions of common spatial orientation.

This application claims priority from provisional application serial No. 60/351,270, filed Jan. 22, 2002, and which is incorporate herein by reference.

### TECHNICAL FIELD

The invention relates generally to a distributed computing system for the creation and distribution of electronic models of objects and more particularly to a system, method and article of manufacture for processing scanned images into electronic model images for end users using a distributed computing system.

### BACKGROUND

Computational resources available for use by various end users of computing systems has increased significantly. This increase in capability of systems has created the ability for many more end users to utilize computer based image systems to replace processes that utilize paper and physical model processes. In the past, computer aided design, drafting, and manufacture (CAD/CAM) tools represented an area of applications in which computer based image systems have migrated from paper and model based processes to electronic systems.

These CAD/CAM system typically consist of design and drafting tools that allow technical designers to build systems that were previously designed on paper using draftsmen. Over time, the computing system and their respective tools have allowed increasing interactive manipulation of components during the design process. This advance in design of items that are then manufactured has occurred using these computer aided systems.

These CAD/CAM systems, however, typically start their processes with a set of predefined libraries of components that may be used by the user of the computing system. For example, electronic schematics possess a library of components that are used to specify a circuit and its layout. The creation of these libraries, as well as the amount of computational resources needed to perform the operations related to these systems, has prevented the wide-spread use of these systems in other areas of technology.

With the advances recently made computational systems, these computer based image systems may be used to permit end users to replace paper and physical models with electronic images. Areas of technology present additional obstacles to the more wide-spread use of these systems. Mainly, a mechanism to capture image representations of physical objects accurately and with sufficient resolution is needed in a form that is both inexpensive to operate while providing rapid turn-around for users.

### SUMMARY

The present invention relates to a method, apparatus, and article of manufacture for processing scanned images into electronic model images for end users using a distributed computing system.

A system in accordance with the principles of the present invention includes a computing system for receiving scanned data for an object that is to be processed to generate an polygonal image that represents the surface of the scanned object. Other embodiments of a system in accordance with the principles of the invention may include alternative or optional additional aspects. One such aspect of the present invention is a method and computer data product encoding instructions for generating an electronic model image constructed using polygons to represent the surface of an object. The method scans an object to generate a plurality of surface points in a common coordinate system and generates a initial polygon representation for the object surface by connecting surface points to nearest neighbors. The method then divides the initial polygon representation into a plurality of regions of common spatial orientation, slices the regions of common spatial orientation into slices that are oriented perpendicular to the common spatial orientation, determines line segments at locations in which the slices intersect the polygons in the initial polygon representation, combines the line segments into a stripe of continuous line segments that represents the surface of the scanned object at the location of the slice, generates a polygonal mesh using endpoints from adjacent stripes of continuous line segments within each region of common spatial orientation, and generates a polygonal mesh using endpoints of continuous line segments along adjacent edges of regions of common spatial orientation.

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described specific examples of an apparatus in accordance with the invention.

### BRIEF DESCRIPTION OF THE DRAWINGS

FIG. 1 illustrates a distributed computing system for the creation and distribution of electronic models of objects according to one embodiment of the present invention.

FIG. 2 illustrates an exemplary computing system useful for implementing an embodiment of the present invention.

FIGS. 3a-b illustrate an example of an object from which a eModel is generated according to yet another example embodiment of the present invention.

FIG. 4 illustrates a representation of the object in FIG. 3 using a polygonal mesh according to an embodiment of the present invention.

FIG. 5 illustrates a simplified representation of the object in FIG. 3 using a reduced polygonal mesh according to yet another example embodiment of the present invention.

FIG. 6 illustrates a format for an eModel data file according to yet another example embodiment of the present invention.

FIG. 7 illustrates an eModel for an impression of a patient's mouth and teeth according to yet another example embodiment of the present invention.

FIG. 8 illustrates an eModel for a shell from a cellular telephone case according to yet another example embodiment of the present invention.

FIGS. 9a and 9b illustrate eModel scanned data processing for items having different geometries according to embodiments of the present invention.

FIG. 10 illustrates a block diagram for an eModel generation and distribution system according to an embodiment of the present invention.

FIG. 11 illustrates mesh processing for a single slice through an object according to an embodiment of the present invention.

FIG. 12 illustrates mesh processing for two adjacent slices according an embodiment of the present invention.

FIG. 13 illustrates an operational flow for the processing performed when processing mesh data according to yet another example embodiment of the present invention.

### DETAILED DESCRIPTION

The present invention relates to a code generation method, apparatus, and article of manufacture for providing a distributed computing system for the creation and distribution of electronic models of objects.

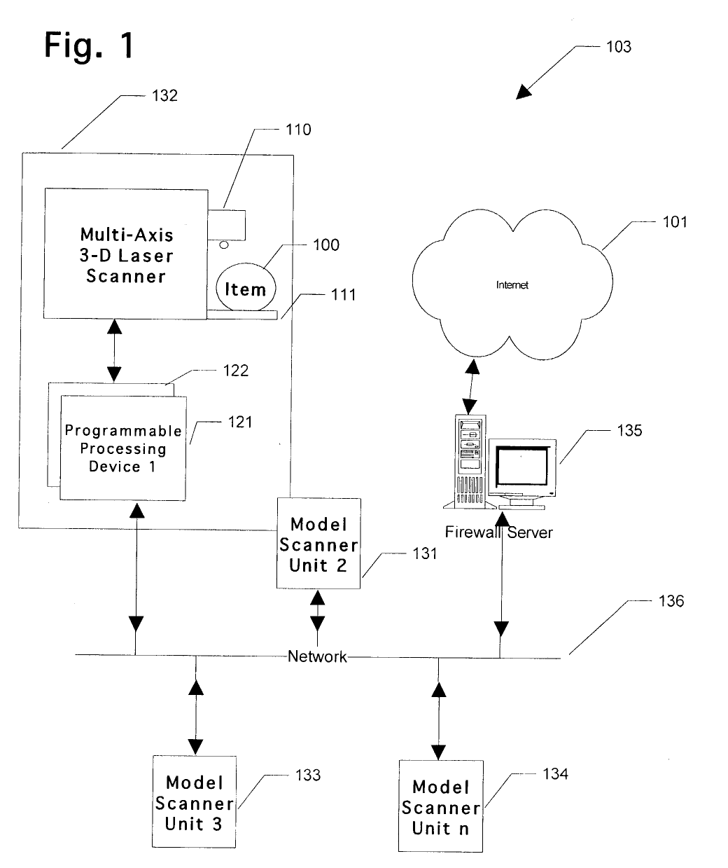

FIG. 1 illustrates a distributed computing system for the creation and distribution of electronic models of objects according to one embodiment of the present invention. End users operate a plurality of different computing systems 110-113 to perform their respective computing tasks. End users typically use one general purpose computing system for a variety of tasks. In order for use of imaging systems to replace paper and model based systems, the imaging system used by end users 110-113 consist of laptop and desktop computing systems.

These computing systems typically possess a mechanism to communicate with other computing systems over a communications network 101. The Internet 101, as a publicly available communications network, provides an available communications path between virtually any two computing systems after they first connect to the Internet. While other communications mechanisms, exist and may be used, the Internet provides a well-known mechanism to communicate data between two computing systems.

In an image-based eModel system, an end user 110 communicates over a communications network 101 to a server 121 to retrieve electronic eModels from a database 122. The end user 122 may be located anywhere a connection to the communications network 101 exists to retrieve the eModels from the database 122. This database 122 may be located within an eModel data server system 102 that is maintained by third-parties that provide maintenance, data back-up, and similar data processing overhead functions that are not an overriding concern for an end user. This data back-up, for example, may consist of long-term archiving of data to replace maintenance of physical models that have in the past required a great deal of effort and expense to complete.

The eModels themselves consist of a data file stored on the server 121 in a database 122 that allows quick and efficient access for users. These eModels are generated in a separate eModel generation system 103 that consists of one or more model scanning units 131-134. These units 131-134 are connected together using a local communications network 136 and a communications path 135 to the Internet 101. As such, eModels, once generated may be transferred to the eModel Data server system 102 for ultimate use by end users 110-113.

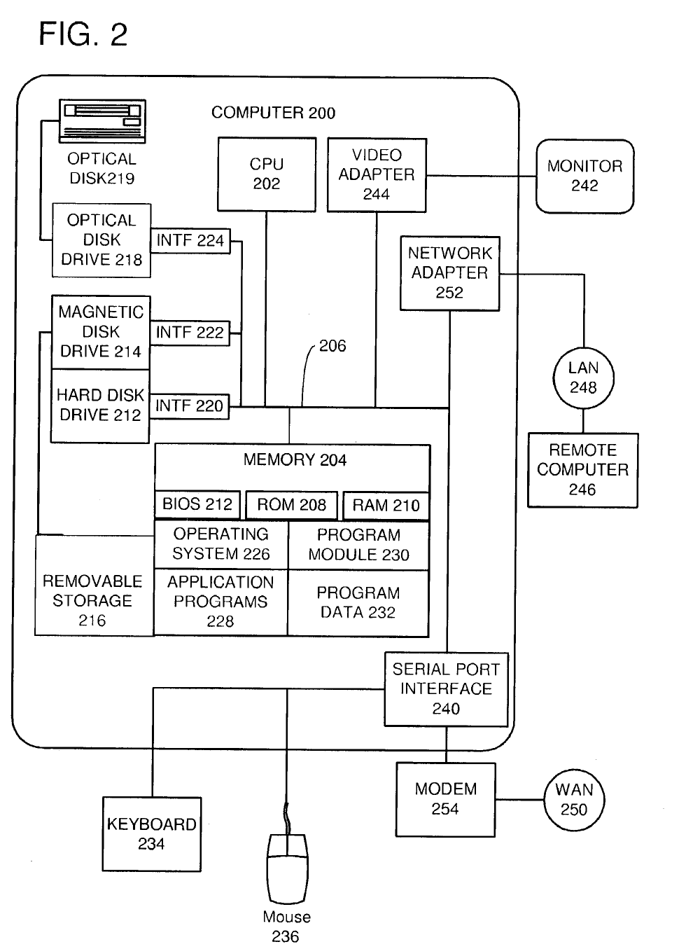

With reference to FIG. 2, an exemplary system for implementing the invention includes a general-purpose computing device in the form of a conventional personal computer 200, including a processor unit 202, a system memory 204, and a system bus 206 that couples various system components including the system memory 204 to the processor unit 200. The system bus 206 may be any of several types of bus structures including a memory bus or memory controller, a peripheral bus and a local bus using any of a variety of bus architectures. The system memory includes read only memory (ROM) 208 and random access memory (RAM) 210. A basic input/output system 212 (BIOS), which contains basic routines that help transfer information between elements within the personal computer 200, is stored in ROM 208.

The personal computer 200 further includes a hard disk drive 212 for reading from and writing to a hard disk, a magnetic disk drive 214 for reading from or writing to a removable magnetic disk 216, and an optical disk drive 218 for reading from or writing to a removable optical disk 219 such as a CD ROM, DVD, or other optical media. The hard disk drive 212, magnetic disk drive 214, and optical disk drive 218 are connected to the system bus 206 by a hard disk drive interface 220, a magnetic disk drive interface 222, and an optical drive interface 224, respectively. The drives and their associated computer-readable media provide nonvolatile storage of computer readable instructions, data structures, programs, and other data for the personal computer 200.

Although the exemplary environment described herein employs a hard disk, a removable magnetic disk 216, and a removable optical disk 219, other types of computer-readable media capable of storing data can be used in the exemplary system. Examples of these other types of computer-readable mediums that can be used in the exemplary operating environment include magnetic cassettes, flash memory cards, digital video disks, Bernoulli cartridges, random access memories (RAMs), and read only memories (ROMs).

A number of program modules may be stored on the hard disk, magnetic disk 216, optical disk 219, ROM 208 or RAM 210, including an operating system 226, one or more application programs 228, other program modules 230, and program data 232. A user may enter commands and information into the personal computer 200 through input devices such as a keyboard 234 and mouse 236 or other pointing device. Examples of other input devices may include a microphone, joystick, game pad, satellite dish, and scanner. These and other input devices are often connected to the processing unit 202 through a serial port interface 240 that is coupled to the system bus 206. Nevertheless, these input devices also may be connected by other interfaces, such as a parallel port, game port, or a universal serial bus (USB). A monitor 242 or other type of display device is also connected to the system bus 206 via an interface, such as a video adapter 244. In addition to the monitor 242, personal computers typically include other peripheral output devices (not shown), such as speakers and printers.

The personal computer 200 may operate in a networked environment using logical connections to one or more remote computers, such as a remote computer 246. The remote computer 246 may be another personal computer, a server, a router, a network PC, a peer device or other common network node, and typically includes many or all of the elements described above relative to the personal computer 200. The network connections include a local area network (LAN) 248 and a wide area network (WAN) 250. Such networking environments are commonplace in offices, enterprise-wide computer networks, intranets, and the Internet.

When used in a LAN networking environment, the personal computer 200 is connected to the local network 248 through a network interface or adapter 252. When used in a WAN networking environment, the personal computer 200 typically includes a modem 254 or other means for establishing communications over the wide area network 250, such as the Internet. The modem 254, which may be internal or external, is connected to the system bus 206 via the serial port interface 240. In a networked environment, program modules depicted relative to the personal computer 200, or portions thereof, may be stored in the remote memory storage device. It will be appreciated that the network connections shown are exemplary, and other means of establishing a communications link between the computers may be used.

Additionally, the embodiments described herein are implemented as logical operations performed by a computer. The logical operations of these various embodiments of the present invention are implemented (1) as a sequence of computer implemented steps or program modules running on a computing system and/or (2) as interconnected machine modules or hardware logic within the computing system. The implementation is a matter of choice dependent on the performance requirements of the computing system implementing the invention. Accordingly, the logical operations making up the embodiments of the invention described herein can be variously referred to as operations, steps, or modules.

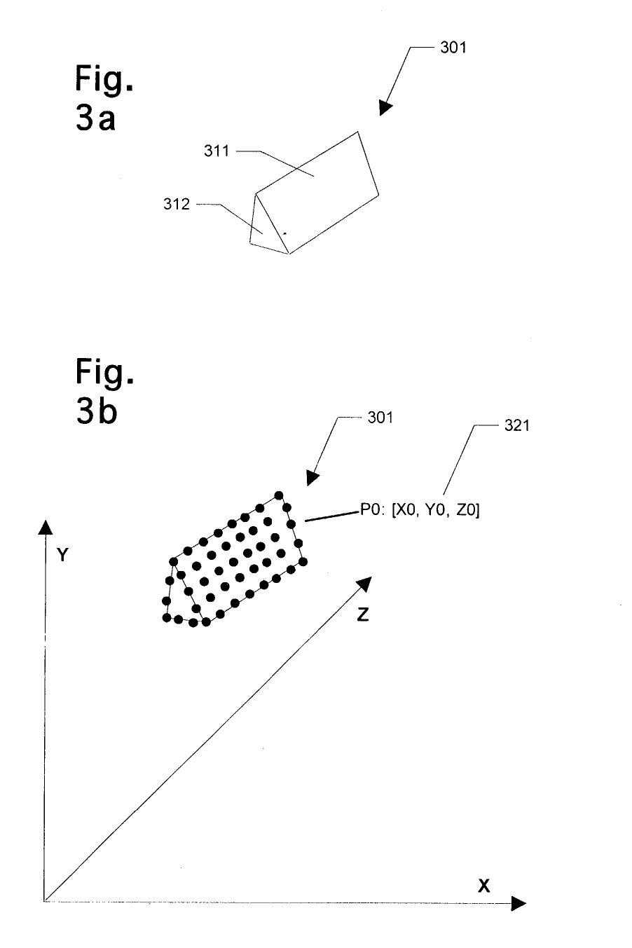

FIGS. 3a-b illustrate an example of an object from which a eModel is generated according to yet another example embodiment of the present invention. A simple geometric 3D shape 301 is presented as an example of how a reduced polygonal mesh is generated that may be used as an eModel. This shape 301 has two visible faces: a small triangular side face 312 and a larger rectangular face 311. Three other faces make up this simple object that are not visible from the perspective shown in FIG. 3a.

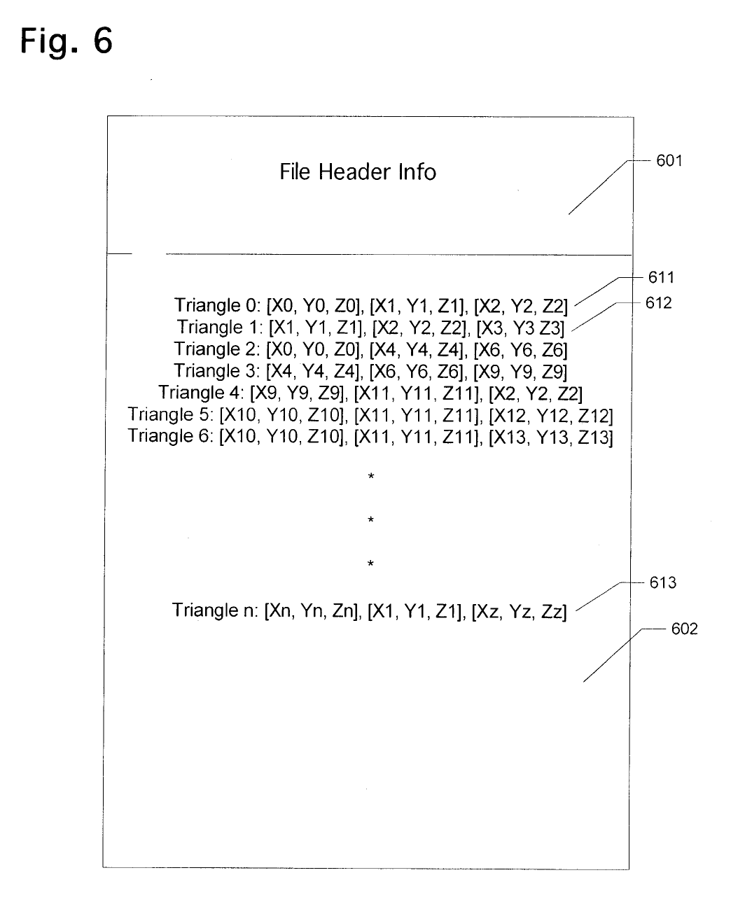

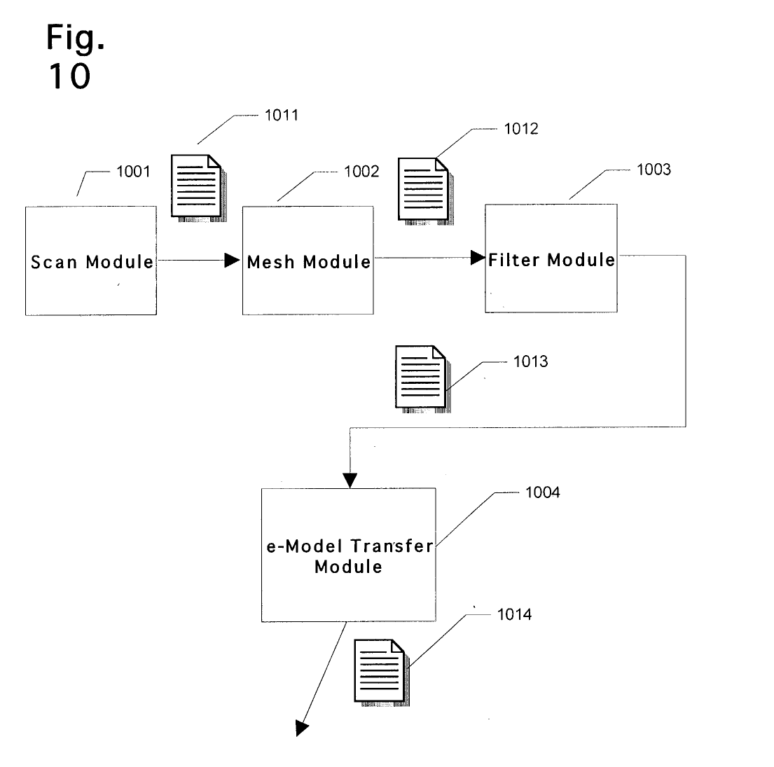

FIG. 3b shows this object 301 having a set of surface data points superimposed upon the object 301 faces. When a laser line scanner passes its sensor over a face of the object 301, a line of points corresponding to the position of the objects' surface are obtained. These points are separated by the spatial resolution of the scanner. The data points, P0 321 are specified using a 3 coordinate position X0, Y0, Z0. As the object 301 is moved within the scanning area of the multi-axis platform, the scanner translates the data points to a common coordinate system such that the collection of all points represents the points in a 3D coordinate system that corresponds to the surface of the item 801. These data points are contained within the point cloud data file described in reference to FIG. 6 that is generated by the scan module 1001 as described in FIG. 10.

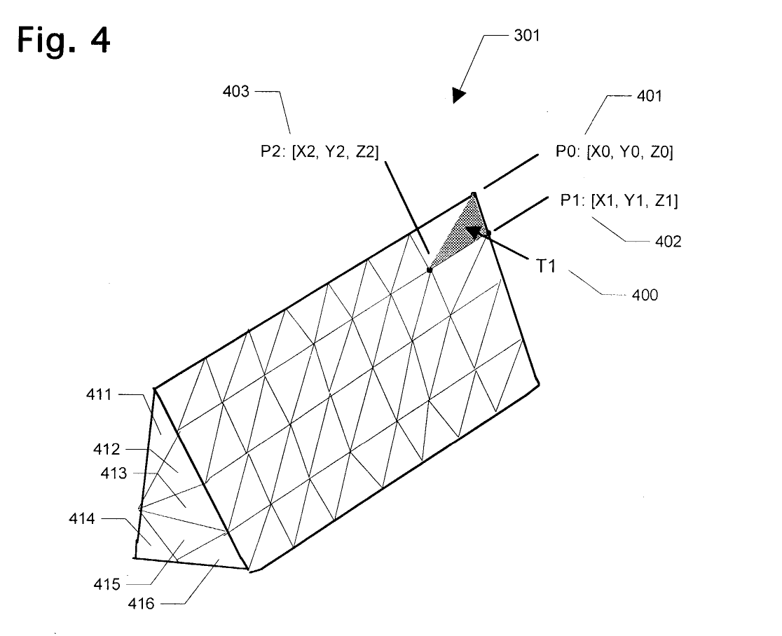

FIG. 4 illustrates a representation of the object in FIG. 3 using a polygonal mesh according to an embodiment of the present invention. As discussed above, the point cloud data file is reduced to a polygonal mesh of triangles in which the surface of the triangles are used to approximate the surface of the item 301. In this example, a triangle, T1 400, is located on the larger surface 411 of the item 401. The triangle T1 400 is specified using the three corner points P0 401, P1 402, and P3 403. As before, each of these three points are specified using a 3D coordinate system such that T1 400 is defined:

T1: {P0, P1, P2 } or

T1: {[X0, Y0, Z0], [X1, Y1, Z1], {[X2, Y2, Z2]}.

Each triangle in the polygonal mesh is specified using the three points as shown above. No particular order for the points making up the triangle is necessary. The smaller side 312 of the item 301 in this example is initially shown with six triangles 411-416. The triangles in the polygonal mesh may be created using any number of well known methods for reducing point position data into a polygonal mesh that approximates the surface of the object.

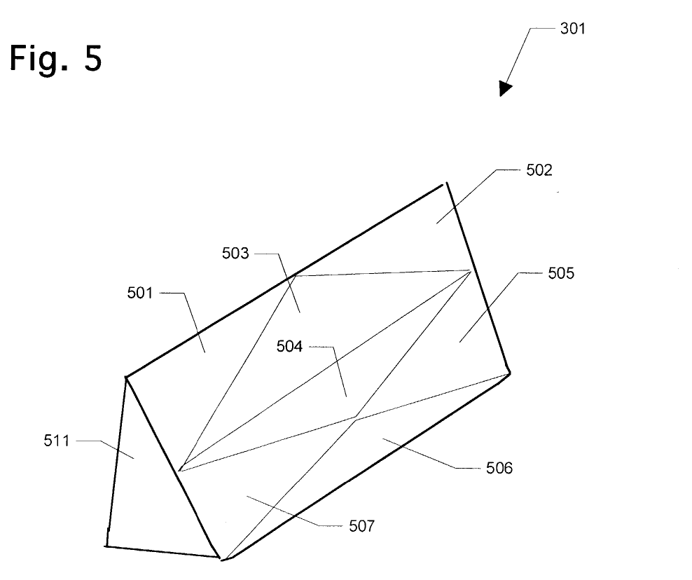

FIG. 5 illustrates a simplified representation of the object in FIG. 3 using a reduced polygonal mesh according to yet another example embodiment of the present invention. A reduced polygonal mesh is generated by combining adjacent triangles in the original polygonal mesh when the two or more triangles are sufficiently coplanar that they may be represented using a single triangle. In this example, a large number of small triangles may have been originally generated mesh shown in FIG. 4. When a flat surface of the simple object 301 is considered, the number of triangles needed is reduced significantly 501-507. In the example, all of the small triangles from the small side 312 of the item 301 have been combined into a single triangle 511. The processing associated with this filtering operation controls the amount of triangle combination by setting a threshold relating to the minimum amount of deviation from a single plane for the two or more triangles that is permitted before two or more triangles are required to remain separate. This filtering process may be accomplished using a number of commercially available polygonal mesh processing products without deviating from the present invention as recited within the attached claims.

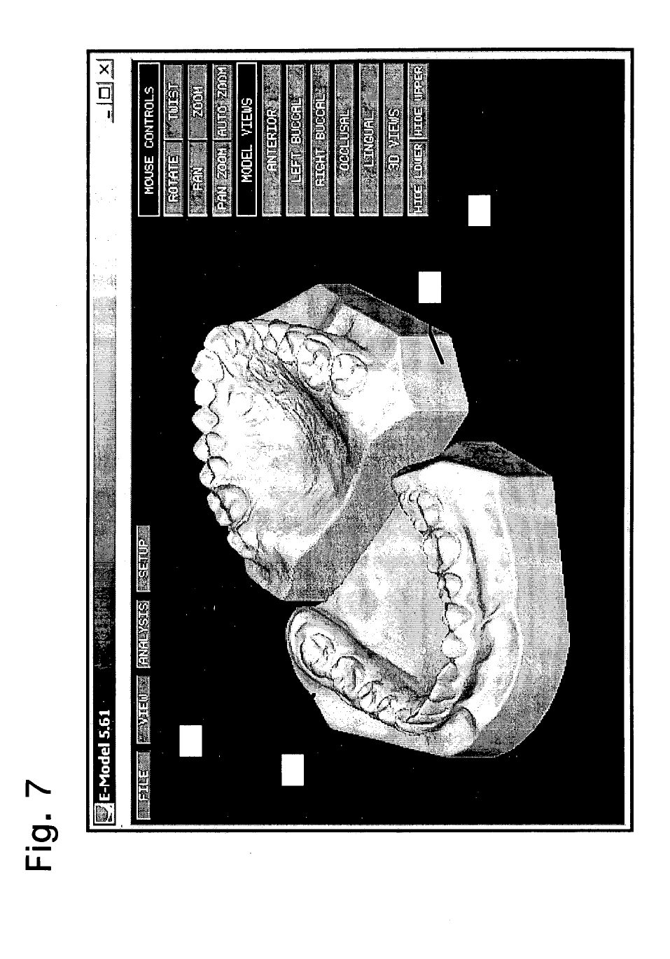

FIG. 6 illustrates a format for an eModel data file according to yet another example embodiment of the present invention. The eModel data file consists of a file header info block 601 and a triangle specification block 602. The triangle specification block consists of the set of triangle definitions 611-613 that are used to define the reduced polygonal mesh. The file header info block 601 includes a set of searchable identification information that may be used to identify a particular model from any number of related models. The mouth and teeth eModels, for example, will likely contain patient identification information such as name, date of birth, address, social security number that may be used to uniquely identify the patient from which the model was generated. The info block 611 may also contain dental care provider information such as the dentist name and address as well as the date on which the impression was taken that generated the eModel shown in FIG. 7.

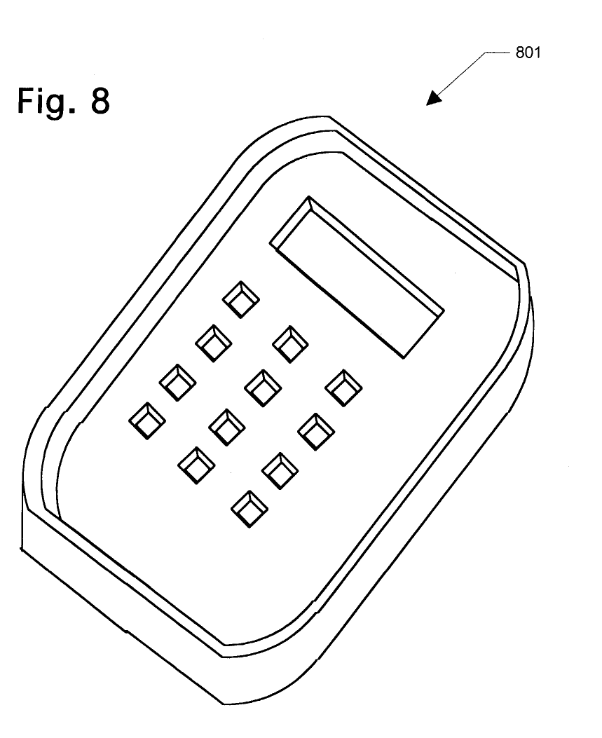

For other items, such as the cellular phone shown in FIG. 8, any useful identifying information may be used. This data is typically ASCII encoded data that may be easily searched and processed as necessary. One skilled in the art will recognize how this file header info block 601 may be modified to include any information needed by a particular application without deviating from the spirit and scope of the present invention as recited within the attached claims.

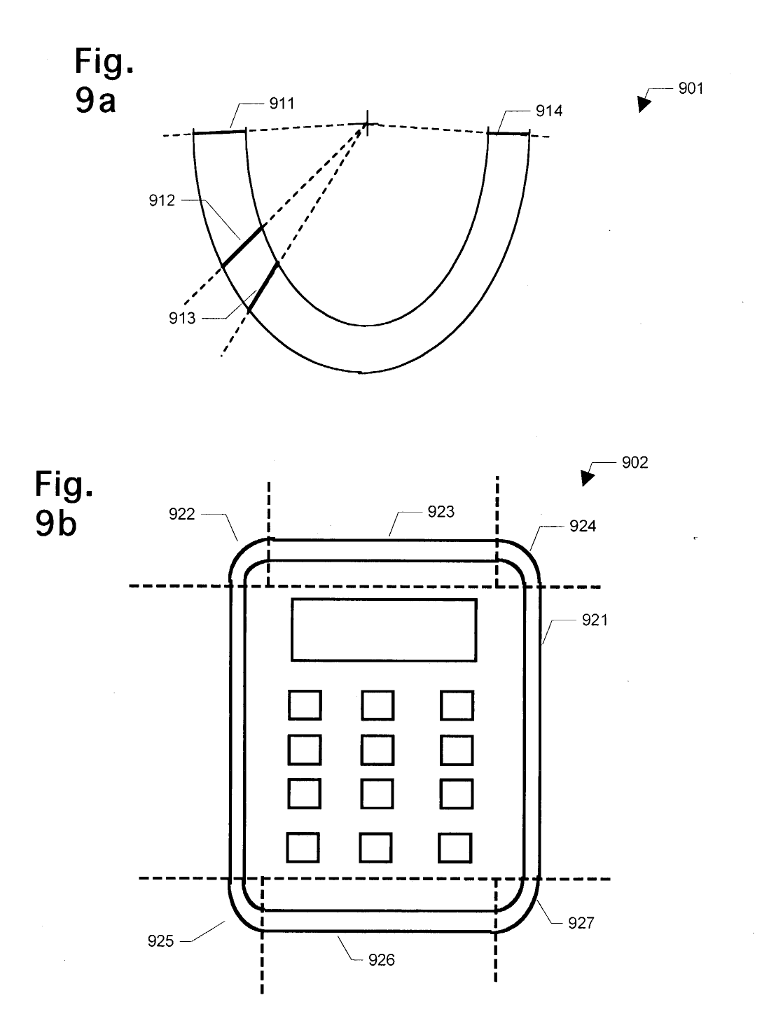

FIGS. 9a and 9b illustrate eModel scanned data processing for items having different geometries according to embodiments of the present invention. In order to reduce the computational complexity of the mesh processing, the object of interest is scanned in a manner that is typically perpendicular to the objects surface. FIG. 9a illustrates an impression of human teeth similar to FIG. 7. The teeth 901 are typically arranged in a parabolic arc about a center. The teeth 901 are scanned and the data is processed into an initial set of polygons as described in FIGS. 3-5. Next, the set of polygon images are sliced into single stripes 911-914 that follow the arc from a first end 911 to a second end 914 of the jaw. A line segment having two end points is created for each polygon in the set of polygon images that is cut by the stripe. These end points of these line segment form a data stripe that represents the surface of the scanned image.

The above process is repeated for a number of individual stripes 912-913 in the middle of the teeth 901 are located at various points along the arc. In one embodiment, two adjacent strips 912-913 would be located a specified minimum distance apart.

FIG. 9b illustrates the cell phone shell of FIG. 8 being divided into several different regions for scanning. The main length of the shell 921 is processed to generate line segment data from an initial polygon surface using horizontal stripes from top to bottom in the manner discussed above in reference to FIG. 9a. The upper end is similarly divided into a center region 923 and two semi-circular regions 922, 924 on its corners. The center region is scanned in vertical strips from left to right. The two corner regions 922, 924 are scanned in arcs similar to the teeth shown in FIG. 9a. The bottom end of the shell 925-927 is divided into regions similar to the top end to obtain the perpendicular strips.

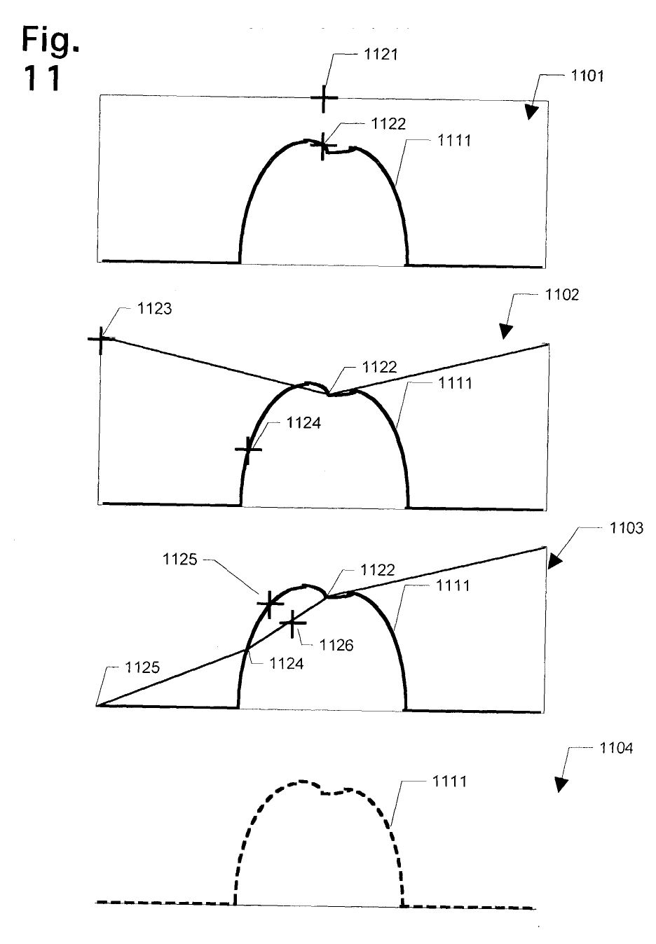

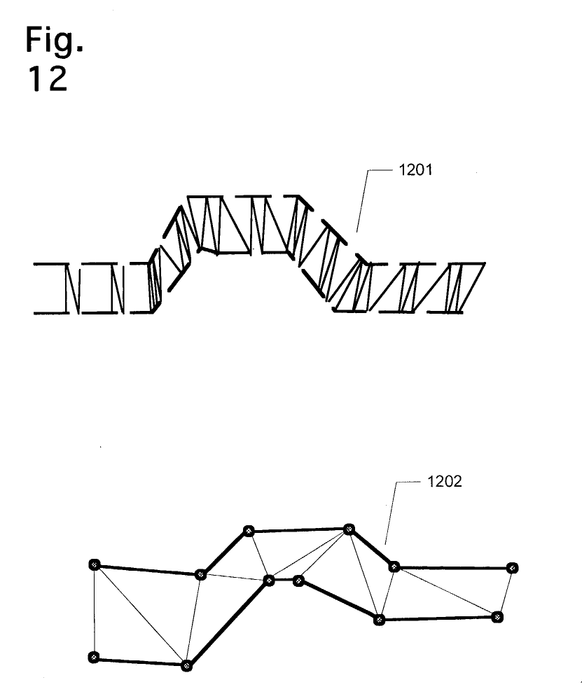

Once these regions are processed, the regions are processed to obtain a set of continuous line segments that match the contour of the item at the stripe. The adjacent stripes are then connected together to form a mesh that may be further reduced as discussed above. This process is illustrated below in reference to FIGS. 11-12.

FIG. 10 illustrates a block diagram for an eModel generation and distribution system according to an embodiment of the present invention. The process for generating an eModel of a user item 300 starts when a scan module 1001 utilizes a scanner 310 to generate a point cloud data file 1011. For objects that typically fit within the 6 inch volumetric cube of the scanner, this point cloud data file 1011 may comprises between 2 and 3 million data points. The large amount of data points generated from the scan of a single user item 300 has posed a significant limitation upon the use of eModels in the past. In the preferred embodiment, the scanning process implemented in the scan module 1001 is performed within the first of two programmable processors 321 within a given model scanner unit 132.

The point cloud data file 1011 represents a data point for each location on the surface of the user item 300. The file is processed into a polygonal mesh of triangles in a mesh module 1002. In this process, the points from the point cloud data file, are organized into triangles of neighboring points that describe the surface of the user item 300 that has been scanned. The creation of a polygonal mesh data file 1012 that contains the specification of all of the triangles, reduces the amount of data to between 100-300 k triangles.

The number of triangles that are used to describe a surface of the user item 300 may be reduced further in a filtering module 1003 when a reduced polygonal mesh file 1013 is created. This reduction of the number of triangles is accomplished when adjacent triangles are sufficiently co-planer to permit the surface described by two or more triangles to be similarly described using a single triangle. The reduced polygonal mesh data file 1013 typically consists of 60 k triangles that permits a manageable amount of data to be used when eModels are processed.

The eModel are completed by an eModel transfer module 1004 that attaches a file header that describes the user item in sufficient detail that it maybe retrieved at a later date. The eModel is contained within an eModel data file 1014 that may be transmitted over the Internet 101 to the eModel data server for storage within its database.

FIG. 11 illustrates mesh processing for a single slice through an object according to an embodiment of the present invention. The scanned stripe of data 1111 in frame 1101 represents the scanned image cloud data from a stripe of data as described in FIG. 9. In order to reduce this data to useful polygons, the stripe of data is converted into a sequence of line segments 1104 that approximates the stripe of scanned data 1111. This generation of the sequence of line segments proceeds as an iterative process that begins with the stripe being represented as three line segments 1120 shown in frame 1101. The center point 1121 of the center line segment is first located. Next a center point for the stripe 1122 is located. The center line segment is divided into two segments from the corner end 1123 to the center point 1122. The other half of the line segment 1120 is treated identically.

This process results in the generation of frame 1102. The process now repeats with line segment end 1123 being used along with a new point on the stripe 1124 . This new point 1124 is located along a line perpendicular to the surface if the stripe 1111. The point 1123 is moved to this new point location 1124 to generate frame 1103. From this frame 1103 a center point 1125 in the new line segment between point 1122 and point 1124 is located. This point is used to find a point on the stripe 1126 along a line perpendicular to the line segment between point 1122 and 1124. Two new line segments from point 1122 to point 1126 and from point 1126 to point 1124 replace the prior line segment. Each of these two line segments are themselves divided in the same manner iteratively until the amount of deviation from the line segments to the stripe data is less than a specified threshold. When complete, the stripe is represented by a sequence of small line segments as shown in frame 1104.

FIG. 12 illustrates mesh processing for two adjacent stripes of data according an embodiment of the present invention. Once the stripes of data are processed into a set of line segments, the end points from the line segments are connected to end points on line segments from an adjacent stripe as shown in FIG. 12 to create a complex mesh 1201. This complex mesh contains a large number of triangles that can be reduced into a eModel image using the process described in reference to FIGS. 4-5. This processing of adjacent stripes is performed only in common regions of scanning an object as described in reference to FIG. 9. Once the region of data has been reduced into a eModel image for the region, the sets of regions are combined using the same process. Polygons are created for all segment end points on an edge of a region image to corresponding segment end points on an adjacent region. These polygons are then reduced as much as possible using the same processing described in reference to FIGS. 4-5. When all of the region images have been combined, the eModel is complete.

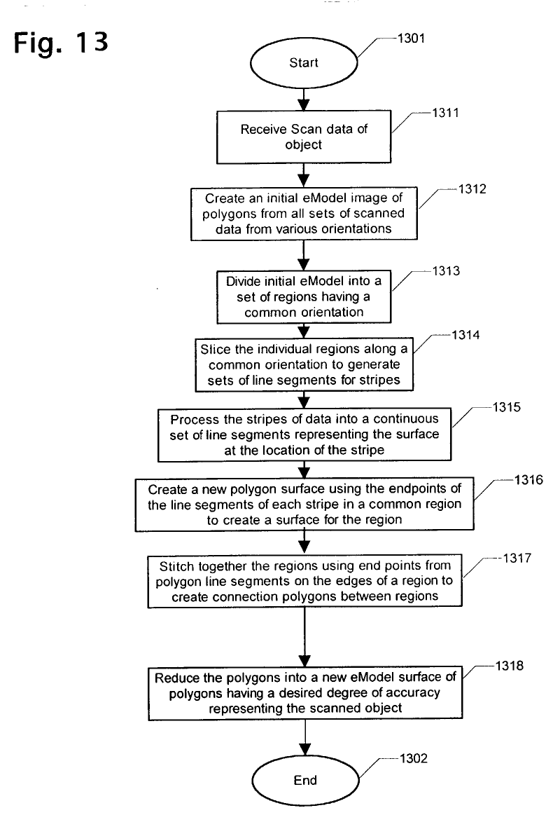

FIG. 13 illustrates an operational flow for the processing performed when processing mesh data according to yet another example embodiment of the present invention. The processing begins 1301 and an input set of scanned data is received in module 1311. The scanned data is a set of point cloud data that represents a surface of an object. Using the scanned data, an initial eModel of polygons that represent the surface of the object is created in module 1312. The model is divided in module 1313 into a plurality of processing regions in which a common spatial orientation is present.

Each region is processed in module 1314 to generate a set of line segments for stripes that are perpendicular to a common orientation for the regions. The line segments correspond to the lines where the polygons from the initial eModel image is sliced. The end points of these line segments are used to define the surface of the object at the location of the stripe in the region of the scanned object.

The end points are processed in module 1315 to generate a continuous set of line segments that represents the surface of the scanned object at the location of the stripe. The end points for the continuous line segments are used to define a polygon mesh for representing the surface of the object between adjacent stripes in a region. The polygon mesh for each region of the scanned object is generated in module 1316. These polygons may be combined to reduce the complexity of the mesh as desired.

Once all of the regions are complete, the regions may be stitched together in module 1317 by generating a polygon mesh using line segment end points on an edge of two adjacent regions of the scanned object. This process is similar to the process used in connecting adjacent stripes of data. The complexity may be further reduced in module 1318 as desired before the processing ends 1302.

FIG. 2 illustrates an example of a suitable operating environment 121 in which the invention may be implemented. The operating environment is only one example of a suitable operating environment 121 and is not intended to suggest any limitation as to the scope of use or functionality of the invention. Other well known computing systems, environments, and/or configurations that may be suitable for use with the invention include, but are not limited to, personal computers, server computers, held-held or laptop devices, multiprocessor systems, microprocessor-based systems, programmable consumer electronics, network PCs, minicomputers, mainframe computers, distributed computing environments that include any of the above systems or devices, and the like.

The invention may also be described in the general context of computer-executable instructions, such as program modules, executed by one or more computers or other devices. Generally, program modules include routines, programs, objects, components, data structures, etc. that perform particular tasks or implement particular abstract data types. Typically the functionality of the program modules may be combined or distributed in desired in various embodiments.

A network server 121 typically includes at least some form of computer readable media. Computer readable media can be any available media that can be accessed by the network server 110. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, BC-ROM, digital versatile disks (DVD) or other optical storage, magnetic cassettes, magnetic tape, magnetic disk storage or other magnetic storage devices, or any other medium which can be used to store the desired information and which can be accessed by the network server 110.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitations communication media includes wired media such as a wired network or direct-wired connection, and wireless media such as acoustic, RF, infrared and other wireless media. Combinations of any of the above should also be included within the scope of computer readable media.

While the above embodiments of the present invention describe a network based processing system providing processing services to remote clients, one skilled in the art will recognize that the various distributed computing architectures may be used to implement the present invention as recited within the attached claims. It is to be understood that other embodiments may be utilized and operational changes may be made without departing from the scope of the present invention.

The foregoing description of the exemplary embodiments of the invention has been presented for the purposes of illustration and description. They are not intended to be exhaustive or to limit the invention to the precise forms disclosed. Many modifications and variations are possible in light of the above teaching. It is intended that the scope of the invention be limited not with this detailed description, but rather by the claims appended hereto. Thus the present invention is presently embodied as a method, apparatus, computer storage medium or propagated signal containing a computer program for providing a method, apparatus, and article of manufacture for providing a distributed computing system for the creation and distribution of electronic models of objects.

What is claimed is:

1. A computer implemented method for generating an electronic model image constructed using polygons to represent the surface of an object, the method comprising:
scanning an object to generate a plurality of surface points in a common coordinate system;
generating a initial polygon representation for the object surface by connecting surface points to nearest neighbors;
dividing the initial polygon representation into a plurality of regions of common spatial orientation;
slicing the regions of common spatial orientation into slices that are oriented perpendicular to the common spatial orientation;
determining line segments at locations in which the slices intersect the polygons in the initial polygon representation;
combining the line segments into a stripe of continuous line segments that represents the surface of the scanned object at the location of the slice;
generating a polygonal mesh segment using endpoints from adjacent stripes of continuous line segments within each region of common spatial orientation; and
generating a polygonal mesh using endpoints of continuous line segments along adjacent edges of regions of common spatial orientation associated with the polygon mesh segments.

2. The method according to claim 1, wherein the polygon mesh generated is specified as a plurality of polygons, the polygons defined a series of endpoints of line segments defining a contour of the polygon.

3. The method of claim 2, wherein the plurality of polygons are defined as triangles.

4. The method according to claim 1, wherein the method further comprises combining coplanar, adjacent polygons to form a new polygon that represents the combined area on the object.

5. The method according to claim 4, wherein two coplanar and adjacent polygons are combined when new surface differs from either of the original two polygon surfaces by less than a predefined distance.

6. A computer program data product readable by a computing system and encoding a set of instructions for providing a computer implemented method for generating an electronic model image constructed using polygons to represent the surface of an object, the method comprising:
scanning an object to generate a plurality of surface points in a common coordinate system;
generating a initial polygon representation for the object surface by connecting surface points to nearest neighbors;
dividing the initial polygon representation into a plurality of regions of common spatial orientation;
slicing the regions of common spatial orientation into slices that are oriented perpendicular to the common spatial orientation;
determining line segments at locations in which the slices intersect the polygons in the initial polygon representation;
combining the line segments into a stripe of continuous line segments that represents the surface of the scanned object at the location of the slice;
generating a polygonal mesh segment using endpoints from adjacent stripes of continuous line segments within each region of common spatial orientation; and
generating a polygonal mesh using endpoints of continuous line segments along adjacent edges of regions of common spatial orientation associated with the polygon mesh segments.

7. The computer program data product according to claim 6, wherein the polygon mesh generated is specified as a plurality of polygons, the polygons defined a series of endpoints of line segments defining a contour of the polygon.

8. The computer program data product of claim 7, wherein the plurality of polygons are defined as triangles.

9. The computer program data product according to claim 6, wherein the method further comprises combining coplanar, adjacent polygons to form a new polygon that represents the combined area on the object.

10. The computer program data product according to claim 9, wherein two coplanar and adjacent polygons are combined when new surface differs from either of the original two polygon surfaces by less than a predefined distance.

11. A system for generating an electronic model image constructed using polygons to represent the surface of an object, the system comprising:
a data communications network;
an electronic scanner electronically coupled to the data communications network; and
a computing system electronically coupled to the data communications network for receiving a set of data points representing the object, the computing system comprises:
a mesh generation module for generating a stripe mesh data set representing a scanned stripe of the object;
a stripe mesh combining module for generating a combined polygonal mesh for the object using the stripe mesh data sets; and
a polygonal mesh combining module for reducing the number of polygons in the combined polygonal mesh by replacing adjacent and coplanar polygons with a single polygon.

12. The system according to claim 11, wherein two coplanar and adjacent polygons are combined when new surface differs from either of the original two polygon surfaces by less than a predefined distance.

13. The according to claim 11, wherein the polygon mesh generated is specified as a plurality of polygons, the polygons defined a series of endpoints of line segments defining a contour of the polygon.

14. The system of claim 13, wherein the plurality of polygons are defined as triangles.
